(19) United States
(12) Patent Application Publication
(10) Pub. No.: US 2015/0359243 A1
(43) Pub. Date: Dec. 17, 2015

(54) METHOD OF PROMOTION OF DRYING OF RICE CONFECTIONARY DOUGH

(71) Applicant: FUJI OIL COMPANY LIMITED, Osaka (JP)

(72) Inventor: Tsukasa KIYAMA, Tsukubamirai-shi (JP)

(21) Appl. No.: 14/730,604

(22) Filed: Jun. 4, 2015

(30) Foreign Application Priority Data
Jun. 5, 2014 (JP) 2014-116315

(51) Int. Cl. A23G 3/36

(52) U.S. Cl. CPC A23G 3/36; A23V 2002/00

(57) ABSTRACT

An object of the present invention is to provide a method capable of easily promoting drying of rice confectionary dough and shortening the drying time without influencing the quality. Rice confectionary dough is dried after adding oils and fats to the dough, thereby allowing drying of the dough after forming to be promoted and the drying time to be shortened.

### CROSS-REFERENCE OF RELATED APPLICATIONS

The present application claims priority to Japanese Patent Application No. 2014-116315, filed Jun. 5, 2014.

### TECHNICAL FIELD

The present invention relates to a method of promotion of drying of rice confectionary dough.

### BACKGROUND

In rice confectionary, there are problems of the productivity being not enhanced and the lead time being long because of a long time required for the production process. In addition, a heavy burden has been forced on producers, because of the necessity of a wide space for production facilities. In the production process, in particular, there is a problem of the drying time of dough being long. In the technique according to Japanese Patent Application Laid-Open No. 60-43340, it is described that a rice confectionary is placed into a wire-net drying drum under slow rotation, which is irradiated with a far-infrared heater provided around the drying drum to allow the rice confectionary to absorb the far-infrared ray and generate heat, with the result that the drying time is shorter than before. However, there is a problem of usable apparatuses being limited, because it is necessary to use the special apparatus for shortening the drying time.

### SUMMARY

Thus, if the problem with the drying time of dough could be solved not by an equipment-based approach but by a simple method such as addition of materials or additives, the method would be more versatile and useful. For example, there have been technologies of adding, e.g., oil and fat and starch in order to improve the texture of rice confectionary (Japanese Patent Application Laid-Open No. 11-341963 and Japanese Patent Application Laid-Open No. 2005-27644), but any technologies on promotion of drying of rice confectionary dough have not been disclosed, and there has been so far no technique for promotion of drying other than equipment-based approaches. An object of the present invention is to provide a method capable of easily promoting drying of rice confectionary dough and shortening the drying time without influencing the quality.

As the result of the intensive studies to solve the above object, the present inventor has found that rice confectionary dough is dried after adding oil and fat to the dough, thereby allowing drying of the dough after forming to be promoted and the drying time to be shortened. In addition, the inventor has found that it is preferable that the oil and fat which are added to the dough be oil and fat showing higher SFC at 30° C. and be in a powdery form, and that the effect is enhanced by oil and fat with a specific surface area being a certain value or higher among the oil and fat in the powdery form, and thus accomplished the present invention.

Thus, the present invention relates to:

(1) a method of promotion of drying of rice confectionary dough, wherein the dough is dried after adding oil and fat into the dough;
(2) the method according to (1), wherein the oil and fat added to the dough is oil and fat showing SFC at 30° C. of 10% or higher;
(3) the method according to (1), wherein the oil and fat added to the dough is oil and fat showing SFC at 30° C. of 20% or higher;
(4) the method according to (1), wherein the oil and fat added to the dough is oil and fat showing SFC at 30° C. of 60% or higher;
(5) the method according to (4), wherein the oil and fat added to the dough is powdered oil and fat;
(6) the method according to (5), wherein a specific surface area of the powdered oil and fat is 300 cm²/g or larger;
(7) the method according to (5), wherein a specific surface area of the powdered oil and fat is 600 cm²/g or larger;
(8) the method according to any one of (1) to (7), wherein the oil and fat is added to the dough so that a content of the oil and fat is 0.01 to 50 wt. % with respect to grain raw material; and
(9) a method of producing rice confectionary, wherein the dough dried by the method according to any one of (1) to (8) is heated.

By the simple method in which the dough is dried after adding the oil and fat to the dough, drying can be promoted, and the time required for drying can be shortened by 5% or more, 10% or more, or 20% or more compared against that of oil and fat-free dough. Since the present invention can promote drying of dough, the time of the process can be shortened to enhance the productivity of rice confectionary.

### BRIEF DESCRIPTION OF THE DRAWINGS

FIG. 1 shows a relationship between the drying time and the water content of dough, when powdered oil and fat A as the oil and fat was added to the dough;

FIG. 2 shows a relationship between the drying time and the water content of dough, when powdered oil and fat B as the oil and fat was added to the dough;

FIG. 3 shows a relationship between the drying time and the water content of dough, when fractionated palm oil, or palm oil as the oil and fat was added to the dough; and

FIG. 4 shows a relationship between the drying time and the water content of dough, when the powdered oil and fat A as the oil and fat was added to the dough by changing the amounts thereof added.

### DETAILED DESCRIPTION

(Rice Confectionary)

Examples of the rice confectionary of the present invention include arare (small rice cookies), okaki (fried rice cakes), senbei (rice cookies), drained products, and rice crackers.

(Oil and Fat)

Vegetable or animal oils and fats can be used for the oil and fat of the present invention. Examples of the vegetable oils and fats include soybean oil, rapeseed oil, palm oil, palm kernel oil, coconut oil, sunflower oil, cotton seed oil, corn oil, rice bran oil, safflower oil, almond oil, peanut oil, and sesame oil, and examples of the animal oils and fats include beef tallow, lard, milk fat and fish oil. Hardened oils, ester-exchanged oils, and fractionated oils of these oils and fats also can be used. In addition, their powdered oils and fats can be used. Furthermore, oils and fats with an emulsifier, an antioxidant and the like added thereto can be used. These oils and fats may be used singly or in combination of two or more.

The SFC at 30° C. of the oil and fat used in the present invention may be 10% or higher, 20% or higher, or 60% or higher, because such oil and fat can enhance further the effect of promotion of drying of rice confectionary dough.

As used herein, the term “SFC” refers to solid-fat content. SFC can be measured, for example according to IUPAC.2.150 (Solid Content determination in Fats by NMR).

Thus, it is preferably that SFC be higher, and examples of the oils and fats showing SFC of 60% or higher include extremely hardened oils such as palm oil, rapeseed oil, and soybean oil. The form of these oils and fats is powdery, the term “powdery” refers to a squamous form or a spherical form, and the form of these oils and fats may be in so-called powder.

Examples of the methods for producing powdered oils and fats include a spray cooling method in which dissolved oil and fat are sprayed into a chiller to be powderized, and a drum flake method in which dissolved oil and fat are flowed onto a cooled drum to be solidified for scraping.

Since the effect of promotion of drying of rice confectionary is enhanced when a specific surface area of powdered oil and fat increases, the specific surface area of the powdered oil and fat may be 300 cm²/g or larger, 600 cm²/g or larger, 700 cm²/g or larger, or 800 cm²/g or larger. With the method by which the specific surface area of the powdered oil and fat is increased, any production methods can be applied, and examples of the methods for producing the powdered oil and fat include a spray cooling method in which dissolved oil and fat are sprayed into a chiller to be powderized, and a drum flake method in which dissolved oil and fat are flowed onto a cooled drum to be solidified for scraping, and preferably is the drum flake method in which dissolved oil and fat are flowed onto a cooled drum to be solidified for scraping. The oil and fat produced by the spray cooling method shows a spherical form, and the oil and fat produced by the drum flake method shows a squamous form.

For the specific surface area, for example, the size of oil and fat is measured by using a micrometer or a particle size analyzer to determine the volume and the surface area from the measured values, and the specific surface area is calculated. A micrometer is used for oils and fats in a squamous form, and a particle size analyzer is used for oils and fats in a spherical form. As the micrometer, for example, MDC 25PJ manufactured by Mitutoyo Corporation can be used. As the particle size analyzer, for example, a laser diffraction/scattering type particle size analyzer can be used, including SRA BASIC manufactured by MicrotracBEL Corp.

The amount of oil and fat added may be in an amount from 0.01 to 50 wt. %, from 0.1 to 20 wt. %, from 0.5 to 10 wt. %, or from 0.5 to 5 wt. % with respect to grain raw material. When the amount of the oil and fat added is not less than the above lower limits, the efficiency of drying of rice confectionary dough tends to improve, and when the amount of the oil and fat added is not more than the above upper limits, the workability during preparing the dough tends to improve.

(Production and Drying of Rice Confectionary Dough)

As raw materials of rice confectionary, in addition to grain raw material, e.g., glutinous rice, non-glutinous rice, foreign species of rice such as Indica rice, various foods such as pulses, vegetables, powder of plant seeds, and starch can be blended.

These raw materials are washed with water, soaked, drained, then being ground, steam-kneaded or steamed, and then being pounded. Oils and fats are added during the pounding step to give dough referred to as mochi (rice cakes) or shinko (rice flour). This dough is subjected to cooling followed by sheet-rolling, die-cutting forming or solidifying, then cutting, or solidifying followed by cut-shaping. The obtained dough is left under a chilled condition for about 0.5 to 5 days.

Then, the resultant dough is dried until the water content reaches a certain value. The water content of the dough before drying is about 40 to 45 wt. %, and for example, the dough is dried until the water content decreases to about 20 to 25 wt. % for okaki and about 10 to 15 wt. % for senbei, respectively. As a drying method, the known method can be employed, including a hot-air drying method and a drying method by sun drying. The drying temperature is about 30 to 80° C. for the hot-air drying method. According to the present invention, the efficiency of drying can be enhanced, and the drying time can be shortened by about 1 to 50% compared to a conventional method during this drying step.

As used in the present invention, the term “promotion of drying” refers to shortening of the drying time by 1% or more, 5% or more, 10% or more, or 20% or more against the drying time of oil and fat-free dough.

The dried dough can be subjected to heating such as baking or frying, thereby producing rice confectionary. The rice confectionary which is produced from the dough dried by the method of promotion of drying according to the present invention is free of problems and good in the quality.

### EXAMPLES

Examples will be described below. Also, “parts” and “%” in Examples mean by weight basis unless otherwise specified.

Powdered oils and fats which were used in Examples were the following oils and fats.

### Powdered Oil and Fat A

A refined palm oil was subjected to extreme hardening to be completely dissolved, then the dissolved oil was flowed onto a cooled drum to scrape solidified oil and fat, and the solidified oil and fat were ground and then subjected to passing through a 12-mesh screen to obtain powdered oil and fat A. The form of the powdered oil and fat A was squamous. The size of the powdered oil and fat A was measured by a micrometer (MDC 25PJ manufactured by Mitutoyo Corporation). The length of the long side, the length of the short side and the thickness of the typical powder of the powdered oil and fat A were 500 μM, 250 μM and 29 μM, respectively. The volume and the surface area were calculated based on these values, being 3625000 μm³ and 293500 μm², respectively. Also, the specific gravity was 0.92. The specific surface area of the powdered oil and fat A calculated from these values was 880 cm²/g, and the SFC at 30° C. thereof was 97%.

### Powdered Oil and Fat B

A refined palm oil was subjected to extreme hardening to be completely dissolved, and then the dissolved oil was sprayed into a chiller to obtain powdered oil and fat B. The form of the powdered oil and fat B was spherical. The size of the powdered oil and fat B was measured by a laser diffraction/scattering type particle size analyzer (SRA BASIC manufactured by MicrotracBEL Corp.). The diameter of the typical powder of the powdered oil and fat B was 150 μm. The volume and the surface area were calculated based on this value, being 1766250 μm³ and 70650 μm², respectively. Also, the specific gravity was 0.92. The specific surface area of the powdered oil and fat B calculated from these values was 435 cm²/g, and the SFC at 30° C. thereof was 97%.

### Example 1

Seven hundred grams of glutinous rice were washed and soaked into water, making use of “quick-soaking function” of a home mochi maker (Toshiba Dough-Kneader & Mochi Maker PFC-20FK), for 42 minutes, and then drained by a metal basket for ten minutes. The rice after draining was 944 g in weight. Then, the drained rice was steamed by the same device for 31 minutes and immediately shifted to a pounding step, and the pounding was conducted for 13 minutes to obtain substantially homogeneous mochi dough. The mochi dough was further pounded for ten minutes, while the powdered oil and fat A was gradually mixed thereto, over about five minutes in the pounding, in an amount of 2.3% with respect to the amount of the glutinous rice (Example 1). On the other hand, dough without addition of the oil and fat thereto was assigned to Comparative Examples (Comparative Example 1).

The pounded mochi was introduced into a forming mold, solidified under chilled conditions (5° C.) over two days or more, and cut into a thickness of 3 mm.

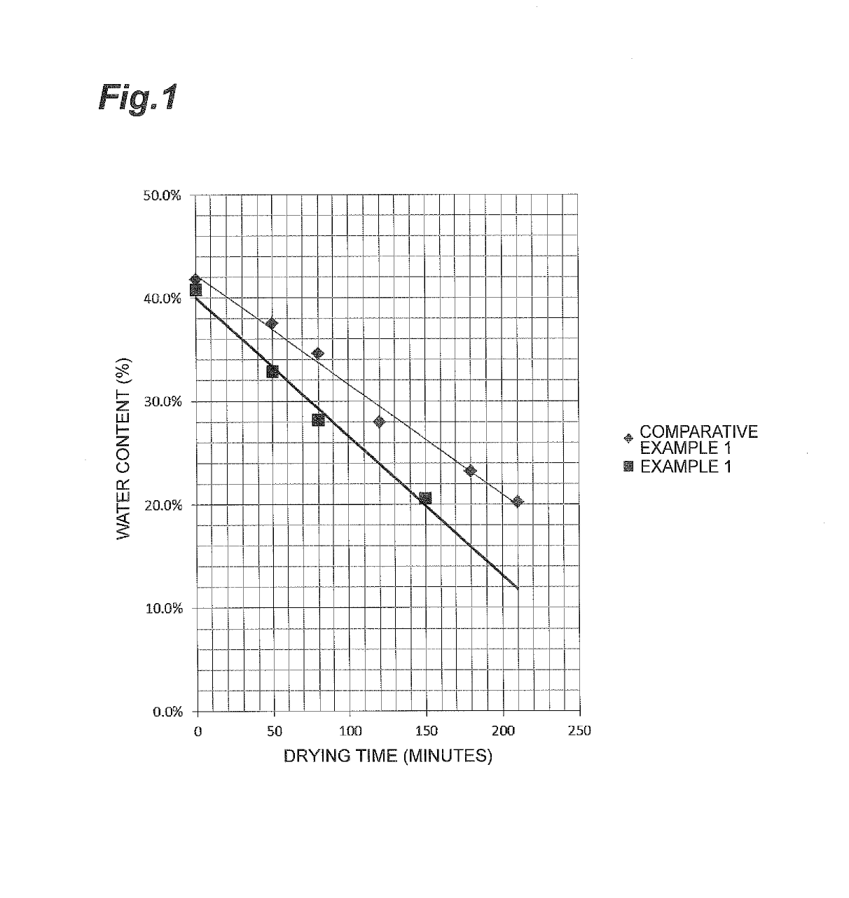

The cut dough was dried in two steps at 30° C. by a dryer (Petit Mini manufactured by TAIKISANGYO Co., Ltd.), and change in the water content was measured during the drying step. The measurement result of the change in the water content during the drying step is shown in Table 1 and FIG. 1.

The dough dried until the water content became 22% was subjected to aging at 20° C. for 12 hours and then to baking by a direct fire burner to produce rice confectionary.

Also, the water content of the dough was measured under the conditions of the temperature at 99° C. and the drying time for 99 minutes by an infrared moisture meter (manufactured by Kett Electric Laboratory Co., Ltd.).

TABLE 1

Water content of dough

| Drying time | Comparative | |
|---|---|---|
| (minutes) | Example 1 | Example 1 |
| 0 | 41.8% | 40.8% |
| 50 | 37.5% | 32.9% |
| 80 | 34.6% | 28.2% |
| 120 | 28.0% | — |
| 150 | — | 20.6% |
| 180 | 23.2% | — |
| 210 | 20.2% | — |

In Example 1 with the addition of the powdered oil and fat A, the drying time was shortened against Comparative Example 1 without the addition of the oil and fat, and the effect of promotion of drying was confirmed. The times, until the water content reached 22%, were 135 minutes in Example 1 and 190 minutes in Comparative Example 1, respectively, according to FIG. 1. Thus, as a result, the drying time was shortened by about 29% by the addition of the powdered oil and fat A.

In addition, there was a small physical property difference of the baked dough and no problem with the quality as rice confectionary.

### Examples 2 to 3

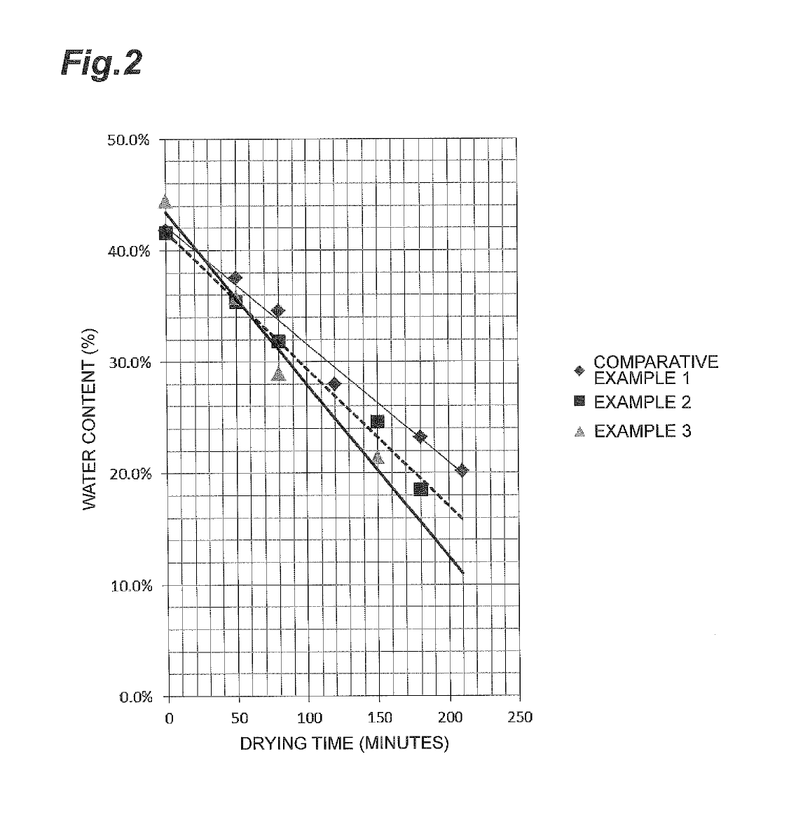

Mochi dough was dried and rice confectionary was produced by using the dried dough as in Example 1, except that the powdered oil and fat B was used as oils and fats which were added to the mochi dough and the powdered oil and fat B was added in an amount of 2.3% or 4.6% with respect to the amount of the glutinous rice (Examples 2 to 3). The measurement result of the water content during the drying step is shown in Table 2 and FIG. 2.

TABLE 2

| | Water content of dough | | |
|---|---|---|---|
| Drying time | Comparative | | |
| (minutes) | Example 1 | Example 2 | Example 3 |
| 0 | 41.8% | 41.6% | 44.4% |
| 50 | 37.5% | 35.4% | 35.7% |
| 80 | 34.6% | 31.8% | 28.9% |
| 120 | 28.0% | — | — |
| 150 | — | 24.6% | 21.4% |
| 180 | 23.2% | 18.5% | — |
| 210 | 20.2% | — | — |

Even when the powdered oil and fat B was used, the speed of drying became faster compared to that of Comparative Example without the addition of the oil and fat, and it was confirmed that there was an effect of promotion of drying. The times, until the water content reached 22%, were 160 minutes in Example 2, 140 minutes in Example 3, and 190 minutes in Comparative Example 1, respectively, according to FIG. 2. Thus, as a result, the drying times were respectively shortened by about 16% in the amount of 2.3% added and by about 26% in the amount of 4.6% added, by the addition of the powdered oil and fat B.

When compared the powdered oil and fat A and the powdered oil and fat B in the same amount added, it was found from the results of Examples 1 and 2 that the effect was more enhanced in the powdered oil and fat A, and that with the use of powdered oils and fats with a larger specific surface area, the effect of promotion of drying was more enhanced.

In addition, there was a small physical property difference of the baked dough and no problem with the quality as rice confectionary.

### Examples 4 to 5, Comparative Example 2

Rice confectionary dough was dried and rice confectionary was produced by using the dried dough in the methods as in Example 1, except that fractionated palm oil (trade name: Palm Ace 10N manufactured by Fuji Oil Co., Ltd., SFC at 30° C.=0%), and palm oil (trade name: Refined Palm Oil manufactured by Fuji Oil Co., Ltd., SFC at 30° C.=9.6%) as the oils and fats were respectively added in an amount of 2% with respect to the amount of the glutinous rice (Examples 4 and 5, respectively).

On the other hand, dough without the addition of the oil and fat thereto was assigned to Comparative Examples (Comparative Example 2).

TABLE 3

| | Water content of dough | | |
|---|---|---|---|
| Drying time | Comparative | | |
| (minutes) | Example 2 | Example 4 | Example 5 |
| 0 | 42.4% | 43.8% | 44.2% |
| 90 | 31.4% | 30.4% | 31.3% |
| 180 | 22.7% | 21.7% | 21.6% |

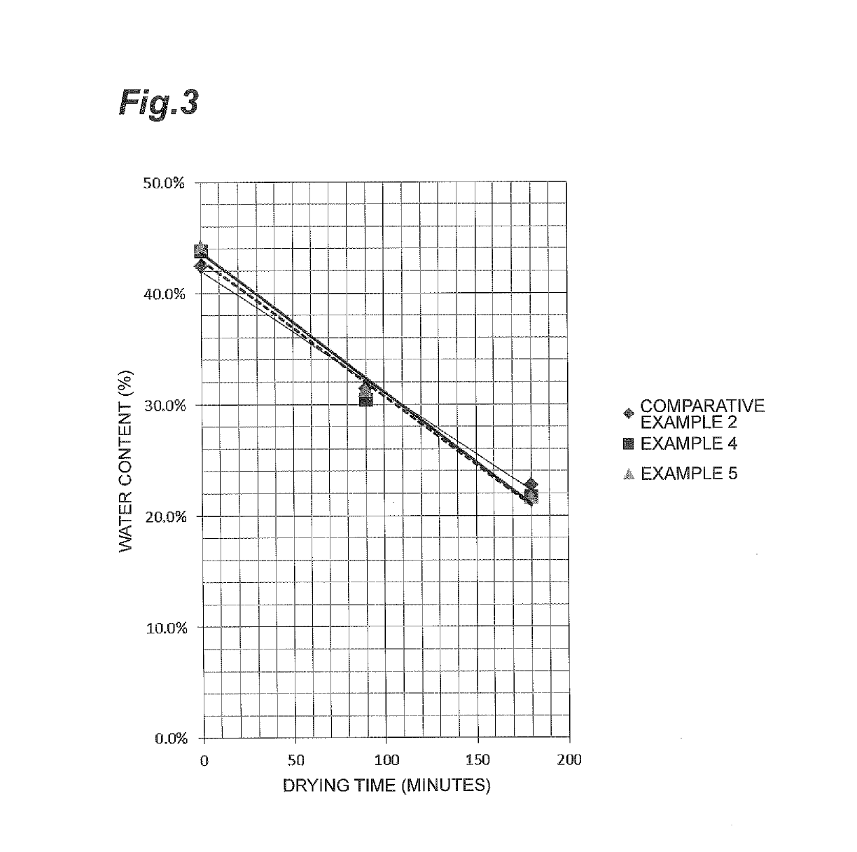

The results are shown in Table 3 and FIG. 3. Both the dough with the addition of palm oil and that with the addition of fractionated palm oil resulted in promotion of drying compared to that without the addition of the oil and fat. The times, until the water content reached 24%, were 155 minutes in Example 4, 155 minutes in Example 5, and 165 minutes in Comparative Example 2, respectively, according to FIG. 3. Thus, as a result, the drying times were shortened by about 6% by the addition of palm oil or fractionated palm oil.

In addition, there was a small physical property difference of the baked dough and no problem with the quality as rice confectionary.

It was found from the results of Examples 1 to 5 that for the effect of promotion of drying, the higher SFC at 30° C. is, the higher the effect is.

### Examples 6 to 11, Comparative Example 3

A relationship between the amount added to glutinous rice and the effect of promotion of drying was investigated by using the powdered oil and fat A as oils and fats.

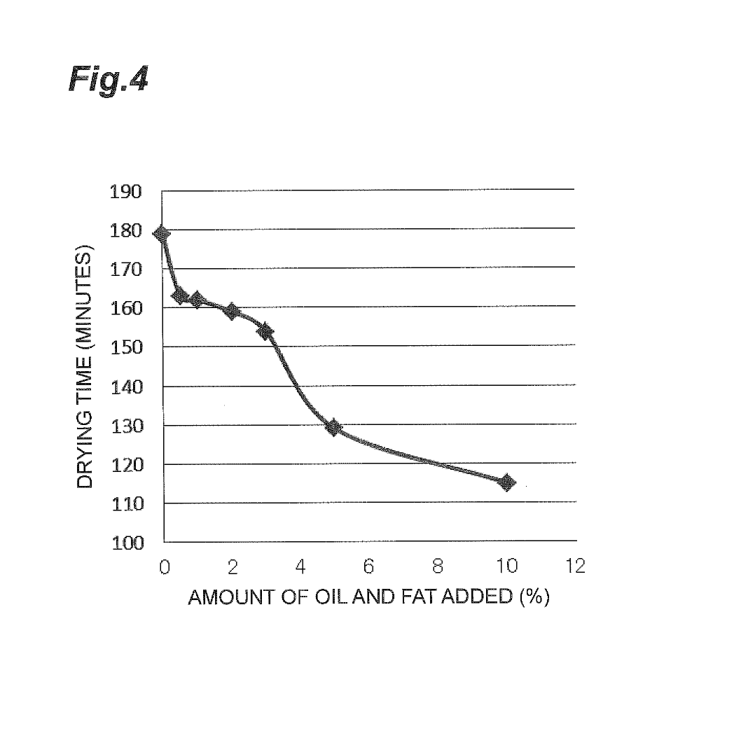

Doughs were produced in the methods as in Example 1, except that the amounts of the powdered oil and fat A added were varied so as to be 0% (Comparative Example 3), 0.5% (Example 6), 1.0% (Example 7), 2.0% (Example 8), 3.0% (Example 9), 5.0% (Example 10), and 10.0% (Example 11) with respect to glutinous rice, and then the thus prepared doughs were subjected to drying to compare the drying times until the water content decreased to 22%. The results are shown in Table 4 and FIG. 4.

TABLE 4

| Amount of oil and | Drying time |
|---|---|
| fat added (%) | (minutes) |
| 0 | 179 |
| 0.5 | 163 |
| 1 | 162 |
| 2 | 159 |
| 3 | 154 |
| 5 | 129 |
| 10 | 115 |

The drying time of the dough without the addition of the oil and fat was 179 minutes. By comparison, the drying times of the dough with the addition of the oil and fat in the amounts of 0.5%, 1.0%, 2.0%, 3.0%, 5.0%, and 10.0% were 163 minutes, 162 minutes, 159 minutes, 154 minutes, 129 minutes, and 115 minutes, respectively, the effect of promotion of drying increased as the increment of the amount of the oil and fat added, and as a result, the drying time was shortened by about 36% in the amount of 10% added. Also, the drying time was shortened even when the amount of the oil and fat added was 0.5%, and as a result the drying was promoted.

What is claimed is:

1. A method of promotion of drying of rice confectionary dough, wherein the dough is dried after adding oil and fat into the dough.

2. The method according to claim 1, wherein the oil and fat added to the dough is oil and fat showing SFC at 30° C. of 10% or higher.

3. The method according to claim 1, wherein the oil and fat added to the dough is oil and fat showing SFC at 30° C. of 20% or higher.

4. The method according to claim 1, wherein the oil and fat added to the dough is oil and fat showing SFC at 30° C. of 60% or higher.

5. The method according to claim 4, wherein the oil and fat added to the dough is powdered oil and fat.

6. The method according to claim 5, wherein a specific surface area of the powdered oil and fat is 300 cm²/g or larger.

7. The method according to claim 5, wherein a specific surface area of the powdered oil and fat is 600 cm²/g or larger.

8. The method according to claim 1, wherein the oil and fat are added to the dough so that a content of the oil and fat is 0.01 to 50 wt. % based on weight of grain raw material.

9. The method according to claim 4, wherein the oil and fat is added to the dough so that a content of the oil and fat is 0.01 to 50 wt. % with respect to the grain raw material.

10. The method according to claim 5, wherein the oil and fat is added to the dough so that a content of the oil and fat is 0.01 to 50 wt. % with respect to the grain raw material.

11. The method according to claim 7, wherein the oil and fat is added to the dough so that a content of the oil and fat is 0.01 to 50 wt. % with respect to the grain raw material.

12. A method of producing rice confectionary, wherein the dough dried by the method according to claim 1 is heated.

13. A method of producing rice confectionary, wherein the dough dried by the method according to claim 2 is heated.

14. A method of producing rice confectionary, wherein the dough dried by the method according to claim 4 is heated.

15. A method of producing rice confectionary, wherein the dough dried by the method according to claim 5 is heated.

16. A method of producing rice confectionary, wherein the dough dried by the method according to claim 7 is heated.

17. A method of producing rice confectionary, wherein the dough dried by the method according to claim 8 is heated.

18. A method of producing rice confectionary, wherein the dough dried by the method according to claim 9 is heated.

19. A method of producing rice confectionary, wherein the dough dried by the method according to claim 10 is heated.

20. A method of producing rice confectionary, wherein the dough dried by the method according to claim 11 is heated.
